(19) United States
(12) Patent Application Publication
(10) Pub. No.: US 2005/0114167 A1
(43) Pub. Date: May 26, 2005

(54) Booking system and method

(76) Inventor: Dean McEvoy, Paddington (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/990,474

(22) Filed: Nov. 18, 2004

(30) Foreign Application Priority Data
Nov. 21, 2003 (AU) 2003906452

(51) Int. Cl. G06F 17/60

(52) U.S. Cl. 705/1; 705/26

(57) ABSTRACT

A method for making bookings, reservations or orders using an interactive voice recognition (IVR) system. A user of a web-based interface requests a booking or order by entering parameters, for example, name of the restaurant, number of people, date and time. The software of the present invention calls the restaurants telephone using the IVR and confirms or rejects (refuses) the booking. The invention allows for the payment of commissions for originating or facilitation of bookings or orders or the registration of participating restaurants. The booking service is paid by the restaurant for successful bookings. Credit is made for cancelled or no-show bookings. The invention includes a loyalty points system that rewards frequent users of the booking service.

### BACKGROUND OF THE INVENTION

1. Field of the Invention

The present invention relates generally to computerized booking and order systems, including customer loyalty programs. More specifically, the present invention relates to using an interactive voice recognition system connected to the Internet for making a booking or order.

2. Description of Related Art

The present invention is disclosed with reference to making reservation bookings at a restaurant. It will be understood that this is provided by way of example and that the invention may be applied to any industry or target businesses where appointments, bookings or orders are made. Examples of such industries include hairdressers, hotels and other forms of accommodation, doctors and dentists, and retail outlets having little or no Internet presence or who don't already have e-commerce capabilities.

The Internet has a large number of web sites, search engines, and directories of information regarding restaurants. The information may include location, type of cuisine, cost, atmosphere, or a rating by customers or a critic. While these support Internet users in selecting a desirable restaurant, none of these sites, engines, or directories has a satisfactory way of facilitating online bookings. Instead, restaurants are approached by a number of advertising proposals for various promotional or business-building media. These include preferred listing in search engines or directories, links to and from related sites, banner advertisements in web browser screens, and others. These media, however, provide no guarantee to the restaurant of the return they will receive.

There have been some attempts to provide on-line booking systems for restaurants. These systems, however, have relied on e-mail or fax communications with the restaurant except for a few US and UK sites (such as opentable.com or toptable.co.uk) that have convinced the restaurants to invest in specialised and sometimes expensive hardware and software that allows them to take fully automated online bookings. The other method requires that the restaurant frequently check for booking requests, a situation which is a change for most restaurants that rely on telephone, answer machine or fax machine messages. E-mail and fax systems are also not well set up to communicate back to the customer either to confirm or refuse the booking request. At least one on-line booking web site requires a restaurant to allocate a certain number of seats per night to be filled by on-line bookings. This, however, has proven to be impractical for many businesses, and has been adopted only by large restaurants that can allocate a regular number of tables.

What is needed is an online booking system that allows the customer to make booking requests on-line and receive an immediate confirmation. In the case of a booking rejection, the system would allow the customer to select alternate parameters (date, time, etc.) for the same restaurant to accept as an alternative, or to select another restaurant. The system would communicate with the restaurant using the telephone, and integrates with the existing booking systems already established at the restaurant. Finally, the restaurant would pay the booking service only for (at least) successful bookings.

### SUMMARY AND OBJECTS OF THE PRESENT INVENTION

The present invention provides an on-line booking method, herein referred to as the “Booking Angel”, which allows an Internet user, after selecting a restaurant, to request a booking, enter desired date, time, number and other information. The booking request is communicated to the restaurant using an interactive voice response (IVR) system, and booking confirmation or refusal is input by using the keys on the phone. This is communicated back to the user while still on-line or sent via email or sms. The restaurant registers for the Booking Angel service and pays for successful reservations booked through the service. Booking Angel has a customer relationship management system attached to it that manages all customer interactions from sign up, ongoing maintenance through to billing and reporting. The system integrates with a call centre and allows communication with restaurants and users via fax, email, phone, sms, post and IVR.

It is therefore the object of the present invention to provide an on-line booking system allowing Internet users to request a booking and receive a confirmation while on-line or via email. It is a further object to allow a restaurant to register for the service and pay for successful bookings through the service.

It is a further object of the present invention to use an IVR system for communication with the requested restaurant to allow the restaurant to accept or refuse the user's booking request.

It is another object to provide alternative communication pathways (such as a call centre) to the restaurant and to the user in the event the IVR pathway is not available.

It is an alternate object of the present invention to provide a value-add proposition for web sites that assist in the deployment of the Booking Angel system allowing web sited to retain users, build content, and increase volume.

It is a yet further object of the present invention to provide a loyalty system for regular customers of the service.

It is an additional object of the present invention to allow customers to provide feedback to the restaurant, possibly in exchange for loyalty points or product or service coupons or other consideration.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 illustrates an overview of the Booking Angel service

FIG. 2 illustrates the detail of the Booking Angel reservation process

FIG. 3 illustrates the use of user and restaurant databases

FIG. 4 illustrates the detail of one embodiment of the Booking Angel billing process

FIG. 5 illustrates the detail of one embodiment of the commission payment process

FIG. 6 illustrates the detail of one embodiment of the loyalty points process

FIG. 7 illustrates the detail of one embodiment of the ratings process

FIG. 8 illustrates the detail of one embodiment of the sign up process

FIG. 9 illustrates the detail of one embodiment of the cancelled bookings process

FIG. 10 illustrates the detail of one embodiment of the No-show booking process

FIG. 11 illustrates the detail of one embodiment of the promotional bookings process

FIG. 12 illustrates the detail of one embodiment of booking commissions process

### DESCRIPTION OF THE BEST MODE AND PREFERRED EMBODIMENT

The invention is a computerized services implemented to assist businesses in attracting and communicating with customers. While the description below uses restaurants as an example, the invention can also be used to assist other retail and service business types.

The invention, or “Booking Angel”, is a subscription booking service for restaurants. The registration process may include the payment of a one-time or subscription fee. Once registered, the restaurant will receive on-line booking requests via IVR telephone and will pay a fee for successful bookings.

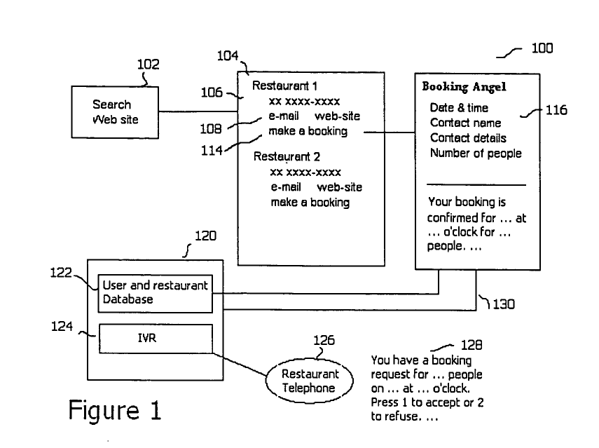

The Booking Angel interacts with an Internet user who desires to make a booking with a subscribed restaurant. The user may reach the Booking Angel web site in a number of ways. These include going directly to the Booking Angel web site or by clicking on a link to the Booking Angel web site. The links to the Booking Angel web site may be placed in another web site, for example, web sites for “city search” type services, restaurants, newspapers and magazines; or in general search engine web sites such as YAHOO or GOOGLE. Referring now to FIG. 1. This illustrates an overview of Booking Angel processing 100. A web site for a partner web site is shown 102 as the starting point for a restaurant booking. The Internet user of this web site selects parameters for a list of possible restaurants based on location, cuisine, price, etc. The list of matching restaurants 104 is displayed to the user for selection. Each entry 106 gives information about the listed restaurant such as restaurant address and phone number. It also includes hyperlinks to additional information about the entry. For example, links to the restaurant's web site 108, to send an e-mail to the restaurant, to show a map and directions, etc. For subscribed restaurants, a link “Book a table” is available 114, which when clicked prompts the user for requested date, time, number of people, and other information 116. This data is sent to the Booking Angel system 120. The Booking Angel combines this data with information contained in a database 122 and creates a voice message 128. This voice message is used by the IVR 124 to call the selected restaurant's reservation phone number 126. The staff at the restaurant answers the phone 126 and hears the voice message 128, and is prompted to accept or refuse the booking by touching keys on the phone's keypad. The staff response is received by the Booking Angel system 120 and sends information back to the user in the form of data streams and preferences 130.

The users must be registered in order to use the Booking Angel. Registration typically is at no cost to the user. During registration, the Booking Angel will collect personal and preference data from the user and store it in a database. A registered user will be assigned a user name and a password that will be used for all bookings made by the user. The personal data collected includes contact name, phone numbers, e-mail address and booking preferences, for example the name of favourite restaurants, and parameters for booking such as time, day of week, and number in the party. The database of registered users may also be used to record an accumulation of “loyalty points” which reward users for making booking using the Booking Angel. Trend data may also be extracted from the information collected. By analyzing where people are booking, the system will be able to infer the most popular restaurants in any geographical region. This can be combined with the user ratings to give an indication of the best restaurants in an area or of a particular cuisine style. By looking at individual booking trends you may be able to make suggestions of restaurants that a user is likely to enjoy.

For example trend data may show that people who visit restaurants A and B also visit restaurant C. So if an individual has already visited restaurant A and B you may be able to suggest restaurant C.

The Booking Angel is a web site providing reservation services. Links to the Booking Angel are located in other web sites. For example, a web site providing “city search” type functions, e.g., locating theatres, events, clubs, as well as restaurants, would include links to the Booking Angel on web pages detailing one or more restaurants matching the search criteria.

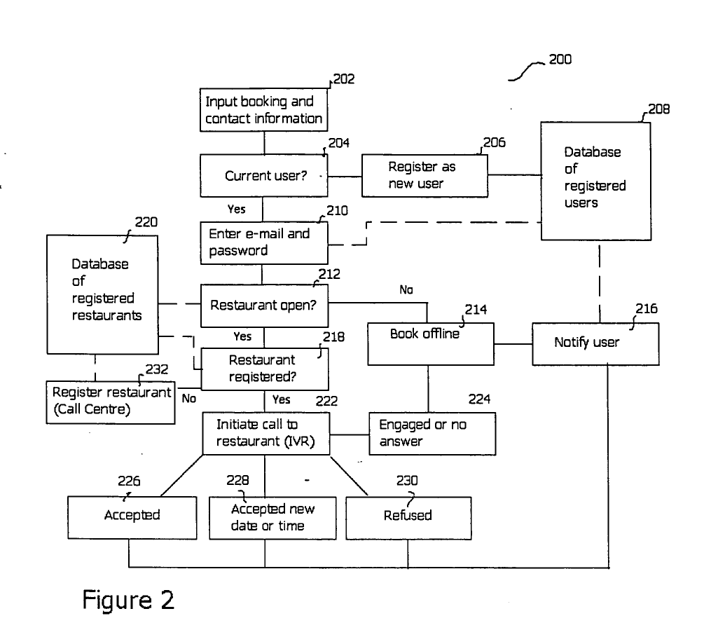

FIG. 2 illustrates the details of one embodiment of the Booking Angel 200. A user using a computer system with a web browser navigates to the Booking Angel web site and indicates a desire to make a booking at a particular restaurant. The user inputs booking and contact information 202. If the user is a current registered user 204, the e-mail address and password of the user as registered is entered. This is checked against the database of registered users 208 and if valid, information about the user is retrieved from the database 208. The database of registered restaurants 220 is checked for the times the restaurant booking telephone is available for booking requests. If the restaurant is not open for booking requests, the user is notified that an attempt will be made to make the booking offline. This is done by holding the information regarding the booking in a queue that is activated when the restaurant is open.

If the restaurant is open for bookings 212 and the restaurant is registered 218, the restaurant is called using the interactive voice response (IVR) 222. If the phone line is engaged or no answer 224, the booking request is added to the offline queue for a later attempt and the user is notified. If the phone is answered by a human operator, an IVR message containing the booking details are played and the human operator is given choices to accept, reschedule, or refuse the booking. This is done by touching keys on the telephone keypad in response to prompts from the IVR.

If the booking request is accepted_-226, the user is notified 216. If the user is still online viewing the Booking Angel web page, the user is given a confirmation message. If the user is no longer online at the Booking Angel web site, the user is notified by e-mail, sms or telephone message, using contact information contained in the database of registered users 208. The details of the booking are entered into the database of registered users 208 for later processing. If the booking request is accepted with a new date or time 228, the user is notified 216 as above. If the booking request is refused, the user is notified 216 as above.

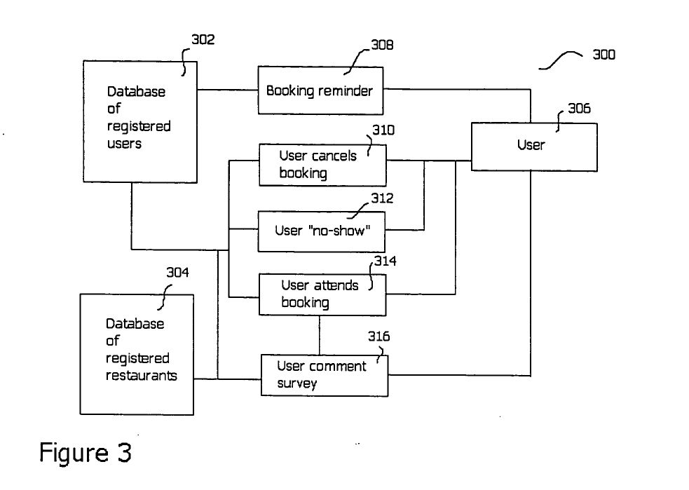

The database of registered users and the database of registered restaurants are used to record the results of the booking, calculate and award loyalty points for the user, and calculate and bill the restaurant. FIG. 3 illustrates one embodiment of these uses of the databases 300. The database of registered users 302 may be used to send the user 306 a booking reminder 308. At the time of making the booking, the user may request a reminder a number of days or hours before the booking, by e-mail or telephone message (IVR or short messaging service, SMS). The reminder requests are stored in the database of registered users and are triggered at the requested time.

The restaurant notifies the Booking Angel, for example, by phone, fax, or e-mail, of the result of the booking. If the booking was successful, that is, the user came to the restaurant at the time of the booking and ordered, then the user may earn loyalty points which are stored in the database of registered users. These loyalty points may be exchanged for goods or services according to the loyalty program details. Loyalty points may also be used in exchange for Booking Angel services, for example, expedited bookings, reminder messages, or preferential seating. The user may also be sent by e-mail a satisfaction or comment survey 316 for the restaurant. Loyalty points may be given the user when they complete the survey.

If the restaurant reports that the user failed to show for the booking 312, the user is notified and a record is made in the database of registered users. This record may be used to penalize or disqualify the offending user, for example, deducting loyalty points or refusing to permit future booking request based on a number of no-show results.

If the restaurant notifies the Booking Angel that the user has cancelled the booking, the database of registered users is updated accordingly.

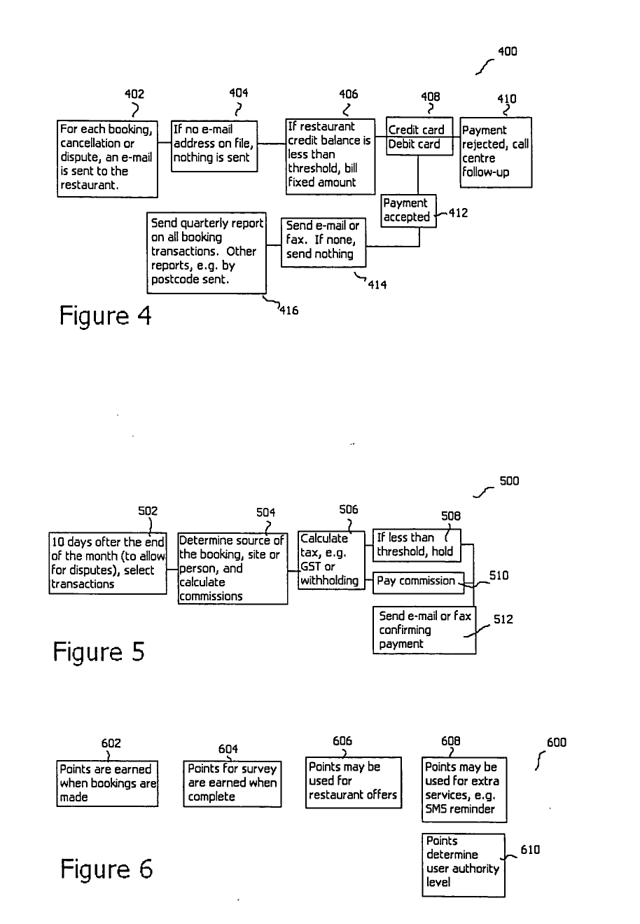

The Booking Angel service is paid by the restaurant for each successful booking. This process is illustrated in FIG. 4. For each booking, cancellation, or dispute 402, the restaurant is notified by e-mail. If there is not e-mail address for the restaurant 404 in the database of registered restaurants, nothing is sent. If the restaurant balance is below a threshold, say $7.00, the restaurant is billed a fixed amount, say $29.50. The threshold is set by the Booking Angel and is typically the same for all registered restaurants. The fixed billing amount may be different for different restaurants. For example, a restaurant with a large number of Booking Angel bookings may wish to have a higher fixed amount. The Booking Angel bills the restaurant's credit or debit card or direct debit out of a bank account 408, the fixed amount. If the payment is rejected 410, the Booking Angel call centre will follow up with the restaurant for payment, or may remove the restaurant from the list of registered restaurants preventing future bookings. If the payment is authorized, 412, a confirmation is sent 414 by fax or e-mail, if available. Each quarter, 416, a detailed report of all booking and billing transactions is sent to the restaurant. The restaurant may also receive other reports, for example, the distribution of bookings by post code.

The Booking Angel may also pay commissions for people or web sites that refer users to the Booking Angel. FIG. 5 illustrates the process of paying commissions. A fixed number of days after the end of a month, say 10 days, which allows time for disputes to be resolved, the successful bookings for the month are extracted from the database of user or restaurants 502. These transactions are examined to determine which site or person referred the user to the Booking Angel. A commission is calculated for each referring person or web site 504. Taxes on the commissions are calculated 506 and withheld or paid to the taxing authority. If the commission amount is less than a threshold, say $10, then the commissions are held until the threshold is reached 508. Commissions more then the threshold, including accumulated held amounts, are paid by a batch payment facility 510. Notification of payment is sent by e-mail to the referring person or web site 512.

The Booking Angel may also award loyalty points to users. FIG. 6 illustrates one embodiment of this process. Loyalty points are earned when bookings are made 602 and are made available five days after the booked date, to allow the restaurant to report if the user kept the booking or not. If the user returns the satisfaction or comment survey, points are awarded and available immediately on receipt of the survey. A number of points may be fixed, say five points for the survey, or may vary based on criteria such as number of questions answered or comments included. The user may redeem loyalty points for goods or services at a restaurant 606. In this case, the restaurant puts together an offer and assigns a number of points needed. Points may also be used for reminder messages or other extra services 608. The number of loyalty points earned may also be used by the Booking Angel to give a user additional privilege, access, authority, or priority 610.

One embodiment of the use of restaurant satisfaction or comment survey is illustrated in FIG. 7. A fixed time, say 1 hour, after the booking time, an e-mail is sent to the user requesting completion of a survey 702. The user confirms that the booking took place 704, and a fixed number of loyalty points, say 25, are immediately awarded. (If the restaurant reports that the user did not appear for the booking, the loyalty points may be retracted, depending on the resolution of the dispute.) A fixed number of points, say 25, is offered for completion of the survey. The survey asks the user to rate the restaurant on a scale for categories such as “food”, “service”, “atmosphere”, “value”, etc 706. The survey includes a place to provide comments if desired 708. The comments and ratings are returned to the Booking Angel and they may be made available to the restaurants 710. The number of loyalty points for each user may be made available 712. In addition, the survey form may include comments about the Booking Angel service. These comments may be used to improve the service, or to provide testimonials on the Booking Angel web site 714.

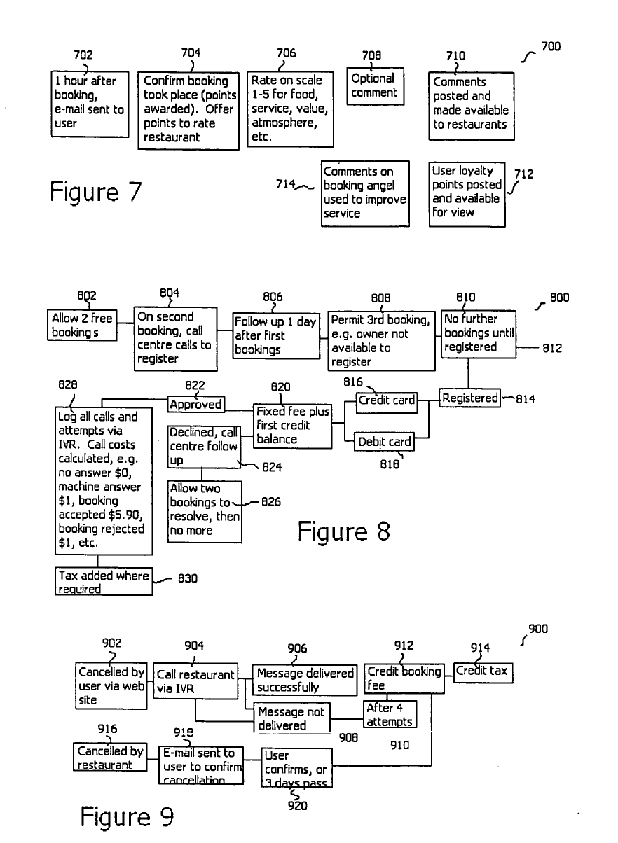

The Booking Angel is paid by the restaurants based on the number of bookings made using the Booking Angel service. Restaurants must be registered and agree to pay for each booking made. FIG. 8 illustrates one embodiment of this process. A user may request a booking at a restaurant that is not yet registered. To allow this, each restaurant is granted a fixed number, say two, free bookings 802. When a second booking is made for an unregistered restaurant 804, the Booking Angel call centre contacts the restaurant for registration and payment details 804. If unable to contact the restaurant, a follow up for the day after the booking is scheduled 806. Once the free bookings are exhausted, a last booking is allowed 808, for example to allow for the case where the owner is not available. After the last free booking is used 810, the restaurant is taken off the system until registration is complete. If the registration is not completed, or if the restaurant declines to be registered, no further actions with the restaurant is taken or allowed 812. If the restaurant is registered, 814, they pay by credit card 816 or direct debit 818, a fixed one-time fee, say $10, and a credit balance amount, say $29.50, which is debited to pay for each successful booking. If the payment is declined, the call centre will follow up 824 and two more bookings will be permitted 826. If the payment is approved 822, the restaurant is registered and available for bookings. Each booking call is recorded and billed according to a schedule, for example, no charge for a call not answered, $1.00 for a call answered by a machine, $1.00 for a call answered and the booking is refused, $5.90 for a booking accepted. There is no charge for an incomplete call. At the end of each call, tax is added to the call charge and subtracted from the credit balance. When the credit balance is below a threshold, the restaurant credit card or direct debit is charged a fixed amount added to the credit balance.

If the booking is cancelled by the user or restaurant, the restaurant is credited the amount charged for the booking. FIG. 9 illustrates one embodiment of this process. If the booking is cancelled by the user using the web site 902, the restaurant is called using the IVR 904. If successful, the amount charged for the booking, say $5.90, is credited 912, including any tax amount 914. If the IVR message was not delivered, for example, engaged or no answer 908, the call is re-queued 904. If re-queued a number of times, say four times 910, the restaurant is credited the booking fee 912 including tax 914. A record is made of the cancellation so any dispute can be resolved. If the booking is cancelled by the restaurant through the call centre 916, a confirmation e-mail is sent to the user 918. The user may confirm the cancellation or after a number of days, say three, the booking fee 912 and tax 914 are credited.

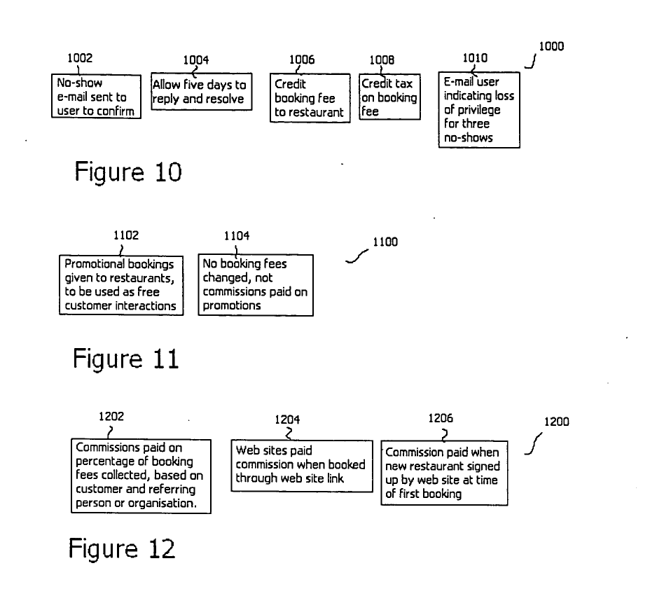

FIG. 10 illustrates one embodiment of a failure of the user to show up for the booking. In this case, the restaurant contacts the Booking Angel call centre or sends and e-mail 1000. The user is notified by e-mail 1002. Five days are allowed for the user to dispute the no-show status of the booking 1004. If not disputed or if disputed and resolved as no-show, the booking fee 1006 and tax 1008 are credited to the restaurant. The user is notified by e-mail 1010, including any warnings or penalties. For example, a user who is a no-show three times is prohibited from using the Booking Angel in the future, or any loyalty points given are retracted.

The Booking Angel also allows for promotional bookings. FIG. 11 illustrates one embodiment of this process. These are credits given to restaurants as rewards for continued service, when a threshold of bookings is reached, etc. These credits are used before any charges are debited from the restaurant credit balance 1102. Promotional bookings are not included in the calculation for any commissions 1104.

Commissions are paid as a percentage of fess paid to the Booking Angel service. FIG. 12 illustrates one embodiment of this process. The percentage paid may vary depending on the customer or organization originating or facilitating the booking 1204. Web sites may be paid a commission for bookings made through links from their web site to the Booking Angel web site 1206. Web sites may also be paid a commission for originating or facilitating the registering of a restaurant 1204.

The Booking Angel provides a web-based, interactive booking system for the customer, and an IVR telephone interface for the restaurant. This is an advantage over current art.

1. A method for making a booking or order, comprising the steps of:
obtaining booking or order preferences from a registered user;
calling a registered business using an interactive voice recognition (IVR) system connected to a computer,
communicating the registered user preferences to a human operator,
and receiving from the human operator confirmation or refusal of the booking or order;
informing the user of the confirmation or refusal of the booking or order; and
collecting a payment from the registered business.

2. The method of claim 1, wherein:
the user interacts with a web-based booking program to enter the booking or order preferences, comprising:
the name of the business
the date and time of the booking or details of item ordered,
the name and contact details of the person making the booking or order.

3. The method of claim 1, wherein:
the user interacts with a web-based user registration program prior to making a booking or order, entering personal information which is stored in a database of registered users.

4. The method of claim 1, wherein:
the business registers as a recipient of bookings or orders by providing a business name and contact information which is stored in a database of registered businesses, providing payment and billing information which is stored in the database of registered businesses, and paying a registration fee.

5. The method of claim 4, wherein:
the business registers by interacting with a web-based business registration program.

6. The method of claim 4, wherein:
the business registers by interacting with a human registration agent and pays a registration fee.

7. Software for the purpose of facilitating a user to make a booking or order with a business using an interactive voice recognition (IVR) system, the software comprising:
a user registration component,
a business registration component, and
a booking or order component.

8. The software of claim 7, wherein:
the user registration component obtains from a user personal and
preference information and stores the information in a registered user database.

9. The software of claim 7, wherein:
the business registration component obtains from a business details about the business, personnel contact information, and payment information and stores the information in a registered business database in exchange for a registration fee.

10. The software of claim 7, wherein:
the booking or order component interacts with a registered user and a registered business and comprises the steps of:
obtaining from the registered user details of a desired booking or order;
communicating the desired booking to the registered business using the IVR system,
obtaining from a human operator at the business a confirmation of the desired booking using the IVR system;
communicating to the registered user the confirmation of the desired booking or order; and
receiving a payment from the registered business.

11. The software of claim 10, wherein:
the payment received from the registered business is returned to the registered business in the case that the registered user subsequently cancels the booking or order.

12. The software of claim 7, wherein:
the user registration component comprises a web-based interactive process.

13. The software of claim 7, wherein:
the business registration component comprises a web-based interactive process.

14. A customer loyalty method for rewarding registered user who use an on-line process for making a booking or oders with a registered business, the method comprising the steps of:
registering a user and entering user information into a user database;
registering a business and entering business information into a business data base in exchange for the payment of a registration fee;
interacting with a registered user to collect a requested booking detail;
communicating the requested booking detail to a human operator at the registered business using an interactive voice recognition (IVR) telephone and obtaining a booking confirmation;
informing the registered user of the booking confirmation, and
rewarding the registered user.

15. The customer loyalty method of claim 14, wherein:
the registered user is rewarded based on the number of bookings or orders made.
